(19) United States
(12) Patent Application Publication
(10) Pub. No.: US 2026/0109384 A1
(43) Pub. Date: Apr. 23, 2026

(54) MOTORIZED HAULING APPARATUS

(71) Applicants: Glen Eric Baker, III, Thurmont, MD (US); Carolyn L. Baker, Thurmont, MD (US); Kenneth Kober, Fairfield, PA (US)

(72) Inventors: Glen Eric Baker, III, Thurmont, MD (US); Carolyn L. Baker, Thurmont, MD (US); Kenneth Kober, Fairfield, PA (US)

(21) Appl. No.: 19/239,364

(22) Filed: Sep. 15, 2025

Related U.S. Application Data
(60) Provisional application No. 63/660,990, filed on Jun. 17, 2024.

(51) Int. Cl. B62B 5/00; B62B 3/04

(52) U.S. Cl. CPC B62B 5/003; B62B 3/04; B62B 2202/70

(57) ABSTRACT

A hauling machine includes a handlebar with a neutral-biased control lever that controls forward, reverse and the speed of the machine. The handlebar includes detents which may be engaged to maintain a set elevation during use. A front caster wheel traverses and articulates relative to the rear drive wheels which include a hydrostatic drive coupled to the control lever such that when the lever is pushed or pulled in a particular direction the hydrostatic drive propels the in either a forward or reverse direction. The amount of displacement of the control lever determines the speed at which the machine travels. A variety of attachments including a hydraulic grapple, wire rope or cable, are provided above the drive wheels for accepting different materials such as limbs, brush, or any other material being hauled. A kill switch is provided for shutting down the machine if the user stumbles.

The application is related to U.S. Provisional Patent Application Ser. No. 63/660,990 filed on Jun. 17, 2024 and claims priority therefrom. The patent application did not receive federal research and development funds.

### FIELD OF THE INVENTION

The present invention relates generally to a motorized hauling machine. More specifically, the machine is a compact motorized apparatus having a front handle with steering and control capabilities. The device is self-propelled and hauls trees, limbs, brush and like materials from a cutting point to a loading and/or disposal point. Ends, of the materials to be hauled, are secured to an upper surface of the rear end of the machine, preferably via hydraulic grapple, a cable or rope loop. The loop encircles the ends to cinch them down to the machine when a handle of a wire winch is turned.

### BACKGROUND OF THE INVENTION

The need for a compact brush hauling machine is great in urban settings. Home owners who have trees on their property sometimes require removal or trimming of trees. This usually results in the hiring of an arborist who climbs the trees and uses saws to delimb and cut the tree. This process creates piles of limbs, trunk parts and other brush including leaves. Usually, the arborist hauls the piles of brush to a wood chipper to be used as mulch around other plants or deposited into a truck for removal.

Hauling brush and tree parts is an exhausting and time intensive process. Moreover, this process is typically done by hand as the size of most building lots in urban settings is small. The brush must be hauled around landscaping features, fences, storage buildings, garages and dwellings. Thus, there is a great need for a motorized brush hauling machine to assist arborists in removing brush and tree parts.

### BRIEF SUMMARY OF THE INVENTION

The compact motorized apparatus has a front handle with steering and control capabilities. The front handle bar is coupled to a frame via a handle bar caster mount that allows the free end of the handle bar to move upwards and downwards. Detents are provided for maintaining the handle bar at a desired elevation to accommodate varying heights of users. In this matter, a shorter person may drop the front end of the handle bar to a more comfortable lower elevation than that used by a taller person.

A tethered kill switch is arranged at the upper end of the front handle bar. The tethered kill switch is coupled to the user's wrist or arm and immediately turns the machine off should the user stumble or fall during use. The upper end of the handle is also equipped with a transaxle engagement lever that operates the machine in either forward or reverse. A hydrostatic transmission transaxle is provided, such that the machine is automatically braked when the transaxle engagement lever is released to prevent it from running over the operator or causing property damage.

In the preferred embodiment, an internal combustion engine is mounted atop the frame for propelling the machine. The engine delivers rotational energy to a centrifugal clutch which in turn drives a belt that transmits energy into the hydrostatic transmission. An engagement handle is provided along the side of the frame allowing the transmission to be decoupled from the drive wheels to allow freewheeling of the machine when disengaged.

The handle of the machine also is equipped with a transaxle engagement lever that operates the machine in either a forward or reverse direction. This handle may be pulled or pushed by the operator in either a forward or reverse direction to drive the machine in a desired direction. A hydrostatic transmission transaxle is provided for driving the rear wheels, such that the machine is automatically braked when the transaxle engagement lever is released to prevent it from running over the operator. The transaxle engagement lever is coupled to the transmission via a cable such that when the lever is pulled forward, the machine is driven in a forward direction. When the transaxle engagement lever is pushed rearward, the machine is driven in a backwards direction. Fenders protect the tires from interference in operation by the hauled brush or tree parts. A brush guard extends across the top of the machine to protect the engine and is arranged between the fenders for prohibiting the hauled brush from damaging the transmission and other internal operating parts of the machine. A brush guard extends along each side as shown in FIGS. 6A-12. An extendable wheelie bar and associated wheels are arranged behind the rear drive wheels and assist in balancing the load and reducing drag when properly deployed. The associated wheels are removed in the second embodiment as shown in FIGS. 6A-12.

In the first preferred embodiment, a wire winch is mounted on a side of the open claw brush clamping apparatus. The wire winch includes wire wrapped around a drum and having a free end formed in a loop that encapsulates a portion of the load that is being hauled. The wire winch is arranged near the bottom of the frame of the clamping apparatus that has teeth. The size of the loop may be increased by disengaging the gear on the wire winch and stripping cable from the spool to encompass a larger load volume. Ends of the tree limbs, brush or other material being hauled, are passed into the loop and thereafter the cable winch gear is engaged and the handle is cranked until the loop has pulled the ends down onto the teeth of the apparatus to secure the load. A generic tray may be utilized for carrying other materials and substituted for the open claw brush clamping apparatus. In a further embodiment as shown in FIGS. 6A-12, a hydraulic grapple and associated equipment is substituted for the fixed claw. The ends of the material being hauled are arranged in the hydraulic grapple and a hydraulic valve is actuated causing the grapple to close about the hauled materials. After the materials are hauled, the valve is actuated in an opposite direction causing the grapple to open and thereby release the hauled materials. A differential lock is also provided in this second embodiment for locking the drive wheels together to aid in removal of material over uneven or slippery surfaces and to prevent spinning of the rear tires.

In a first embodiment a universal swivel mount couples either a brush clamping claw or the generic tray to a top side of the frame. The mount includes a traversing bearing arranged between a pair of pillow block bearings which allows the claw to not only traverse from side to side but to allow the frame, front wheel, and handle to elevate and descend relative to the brush being hauled. A hitch pin is utilized for quickly changing the brush clamping claw with the generic tray or clamp tray. A second embodiment of the universal swivel mount includes additional springs for self-aligning of the mount during use. A hydraulically actuated claw is provided in the second embodiment which includes a valve having a lever for opening and closing the claw such that tree debris may easily be grasped and released in a time efficient manner.

It is a general objective of the present invention to provide a reliable and cost-effective compact device and method for easily removing brush, limbs and tree parts from residential settings in urban environments. Another object of the invention is to remove trees or tree parts and create minimal damage to the existing and remaining landscape compared to other industry machinery utilized to remove trees and tree parts.

A primary objective of the present invention is to provide a motorized machine to which the ends of brush, limbs, tree parts and the like may be attached and thereafter easily hauled from a cutting point to a collection or disposal point.

Another object of the present invention is to provide a self-propelled device capable of traversing tight uneven sloped ground while hauling yard wastes.

Yet another objective of the present invention is to provide a simple means for increasing the productivity of arborists and the like when removing trees and tree parts from a yard.

### BRIEF DESCRIPTION OF THE DRAWINGS

FIG. 1 is a perspective view of an embodiment of the motorized hauling machine of the present invention.

FIG. 2 is a side view of FIG. 1.

FIG. 3 is a rear view of FIG. 1.

FIG. 4 is an overhead view of FIG. 1.

FIG. 5A is an exploded view of FIG. 1.

FIG. 5B is an enlarged exploded view of the universal swivel mount.

FIG. 5C is an enlarged exploded view of the open claw bush clamping device mounted atop the universal swivel mount.

FIG. 6 is an overhead perspective view of the machine having a hydraulic actuated grapple and associated parts.

FIG. 7A is a plan view of the machine of FIG. 6A shown from the side.

FIG. 7B is a rear view of the second embodiment.

FIG. 8A is a perspective view of the second embodiment shown from the right side.

FIG. 8B is a perspective view of the left side of the second embodiment.

FIG. 9 is an exploded view of the frame and associated support structures of the machine.

FIG. 10 is an exploded view of the various parts which actuate the hydraulic claw mechanism.

FIG. 11A is a enlarged exploded view of the second embodiment of the universal mount. FIG. 11B is an enlarged view of the assembled second embodiment of the universal mount.

FIG. 12 is a partial enlarged perspective view of the second embodiment of the machine.

### LIST OF NUMERALS

The following part numbers reference the parts shown in the various drawings.
Machine—1
Handle bar—10
Tethered Engine Kill Switch—11
Transaxle Engagement Lever—12
Transaxle Engagement Cable—13
Handle Bar Mount—14
Handle Bar Bearing—15
Frame—20
Fender—21A, 21B
Brush Guard—22
Wheelie Bar Mounts—23A, 23B
Drive Wheels—24A, 24B
Hydrostatic Transmission Transaxle—25
Steering Caster—26
Steering Caster Bearing—27
Wheelie Bar Wheels—28A, 28B
Wheelie Bar—29
1^{st} Embodiment of Universal Swivel Mount—30
2^{nd} Embodiment of Universal Swivel Mount—30A
Hitch Pin—31
Pillow Bearing—32
Traverse Bearing—33
Swivel Base—34
Swivel Spring Mounts—35, 35A, 35B, 35C
Swivel Spring—36
Open Claw Brush Clamping Apparatus—40
Hydraulically Actuated Claw—40A
Wire Winch—41
Wire Winch Cable—42
Wire Winch Hook—43
Clamp Frame—44
Teeth—45
Generic Tray—48
Engine—50
Engine Roll Cage—51, 51A, 51B
Centrifugal Clutch—52
Drive Belt—53
2^{nd} Drive Belt—53A
Freewheel/Engagement Lever—54
Differential Lock Lever—55
Hydraulic Tank—100
Hydraulic Valve—101
Hydraulic Pump—102
Hydraulic Drive Pulley—152A
Hydraulic Cylinder 110
Spring 301
Arcuate Spring Support 302
Spring Support 303

### DETAILED DESCRIPTION OF THE INVENTION

The present invention is a machine which adds mechanical advantage to a manual operation in the tree-care industry. Ordinarily, arborists must manually retrieve limbs and brush by dragging them from the location where they are cut to a chipper or trailer or other disposal location. This invention aids in removal of tree parts and brush by mechanically hauling them across uneven terrain while the user walks ahead of the machine to reduce body fatigue while creating minimal damage to the terrain.

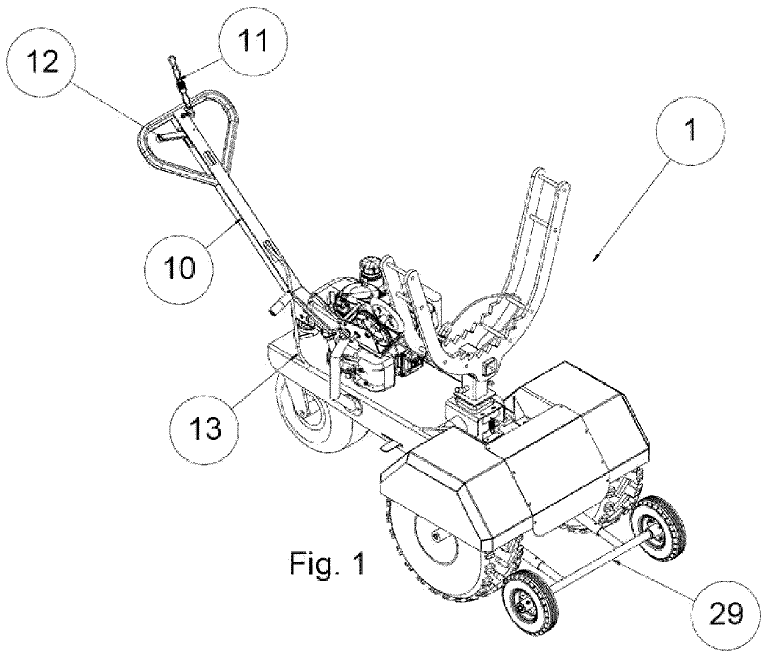

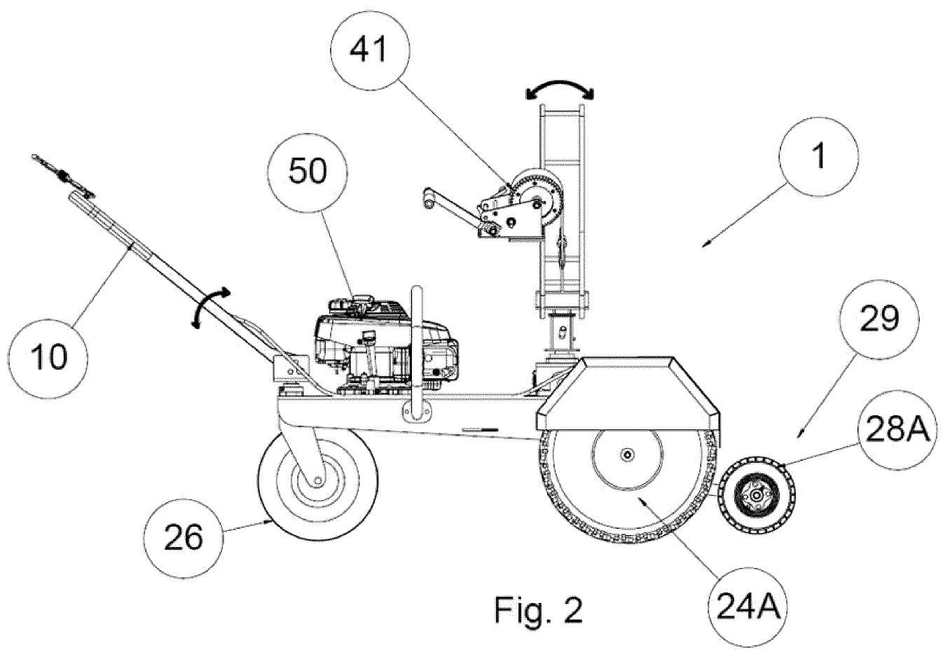

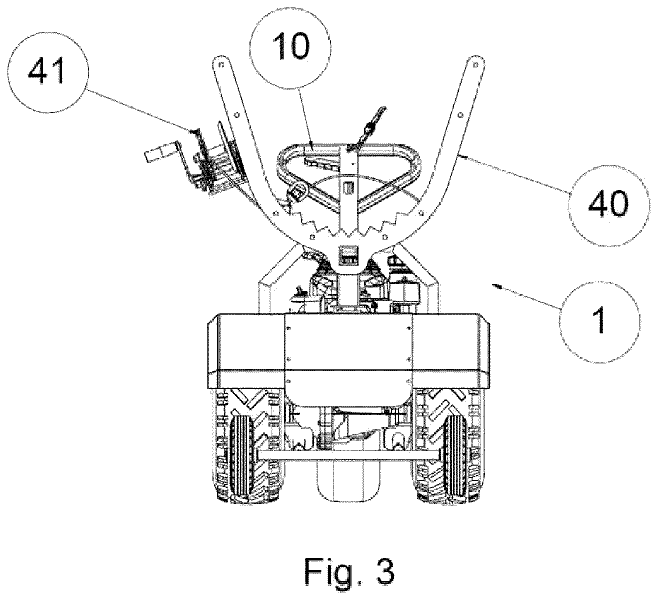

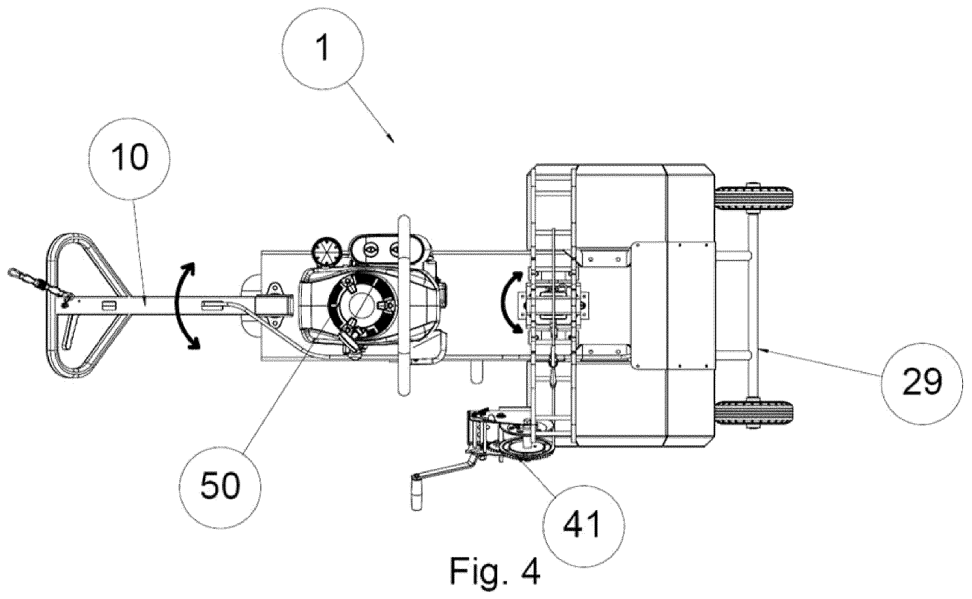

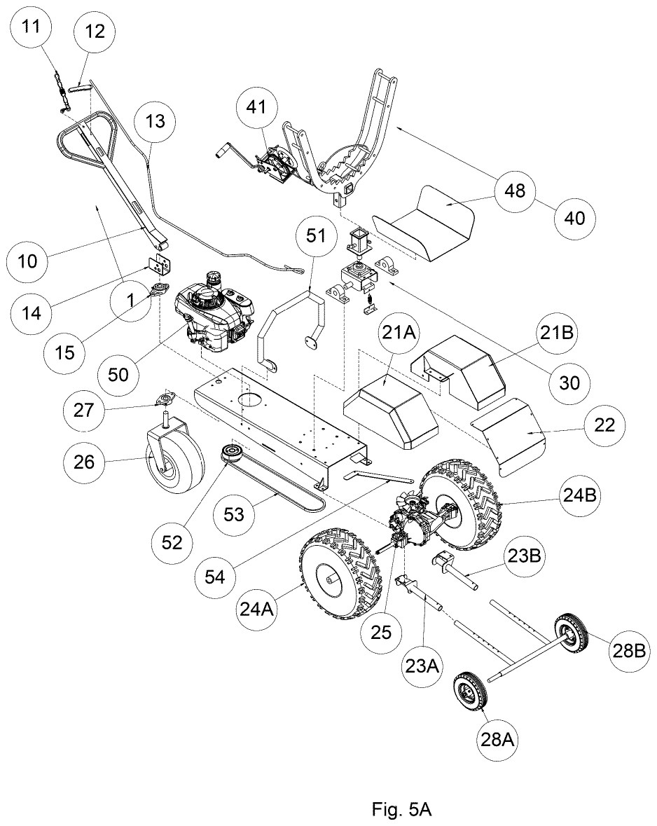

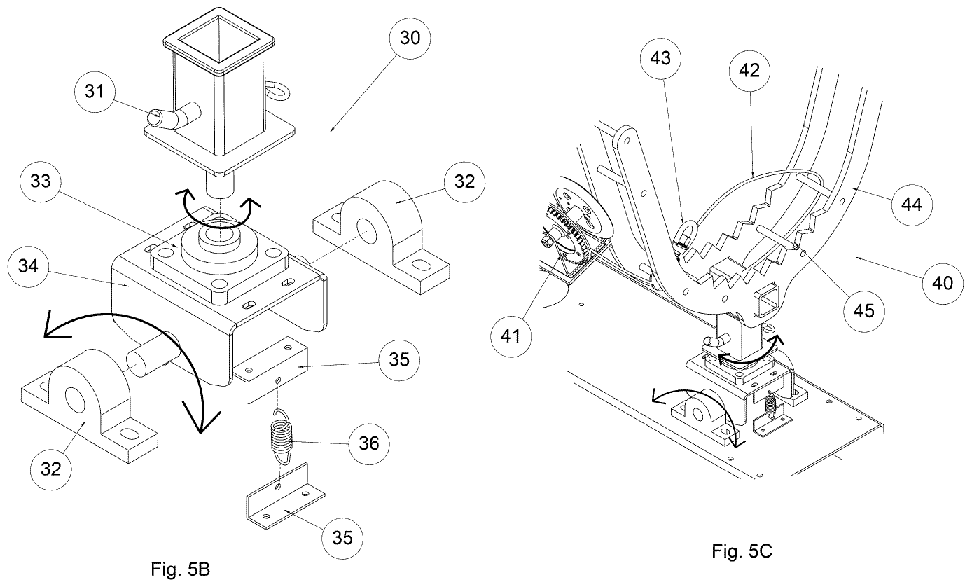

FIG. 1 is a perspective view of a first embodiment of the machine 1 which includes a front end and a back end. A handle bar 10 is rotatably affixed to the front end. The handle bar 10 includes detents which engage holes in the handle bar mount as more clearly seen in FIG. 5A. In this manner, the forward end of the handle bar 10 may be raised and lowered and maintained at the desired height. The drawings only show two detent openings on either side of the handle bar mount 14. However, it should be understood that additional detent openings may be provided. The handle bar mount 14 couples the handle bar 10 to the frame 20. A handle bar bearing 15 is arranged between the mount 14 and the frame 20 to allow the handle bar 10 to traverse from left to right. A pneumatic caster 26 is attached to the lower side of the front end of the frame via a caster bearing 27. In this manner, the machine is easily steered by the user.

A tethered engine kill switch 11 couples the machine 1 to the user during operation such that disconnection between the two will result in the engine being shut off and the machine's movement being stopped. A free end of the switch is coupled to the user via a carbineer, a loop or the like. Thus, the machine 1 is automatically shut off should the user trip and fall.

A transaxle engage lever 12 is also attached to the forward end of the handle bar 10. One end of the lever 12 is pinned to the handle bar 10 such that the other end may be rotated in either a forward or backward direction. A transaxle cable 13 attaches to the lever 12 and extends across the frame 20 and to the hydrostatic transmission transaxle 25. In this manner, the lever 12 may be pulled forward to cause the machine to follow the user in a forward direction. The lever 12 may be pushed in a rearward direction causing the machine to travel in a reverse direction. The speed of the machine is controlled by the amount of displacement of the lever 12 in either direction. The lever 12 is spring loaded towards a neutral position such that when released the machine 1 will return to neutral and rotation of the wheels stops. This acts as a secondary safety should the user release the handle.

A small internal combustion engine 50, such as a lawn mower engine, is attached to a top side of the frame 20 and is protected via an engine roll cage 51. A centrifugal clutch 52 is coupled to the output shaft of the engine 50. A drive belt 53 communicates power from the engine 50 to the hydrostatic transmission transaxle 25 to cause the drive wheels 24A, 24B to be turned in either a forward or reverse direction. A freewheel engagement lever 54 is provided along one side of the machine 1 for disengaging the transaxle 25 to allow the machine 1 to be easily moved. A wheelie bar 29 is mounted to the transaxle 25 via mounts for use in stabilizing longer loads. Detents are utilized for extending or retracting the wheelie bar 29 to a desired length.

Protective fenders 21A, 21B and a brush guard 22 are provided to ensure that brush and limbs will not damage the transaxle 25 or other moving parts of the machine 1. A universal swivel mount 30 with a hitch pin 31 allows for a variety of attachments to be affixed to the top of the machine 1. The mount 30 includes a swivel base 34 mounted to the top side of the frame 20 via pillow bearings 32, each accepting a complementary cylindrical extension as shown in FIG. B. This allows any affixed attachment to articulate in a forward or reverse direction with respect to the frame 20. A traverse bearing 33 is arranged in the mount to allow the load to traverse in left and right directions with respect to the frame 20. In this manner, any hauled load follows the machine's direction of travel without abruptly swinging the rear of the load as the machine 1 turns. A spring 36 and a pair of swivel spring mounts 35 bias the mount in a preferred upright position.

Two attachments are shown in FIG. 5A. These include the open claw brush clamping apparatus 40 and a generic tray 48. Either may be coupled to the machine via the universal swivel mount 30. The open claw brush clamping apparatus 40 comprises a frame 44 having an upper side with teeth 45 for engaging the brush or limbs that are loaded onto the machine. A wire winch 41 preferably includes a cable 42 having an end that is formed in a loop which encircles an end of the brush that is hauled. The wire winch handle is then rotated to cinch the cable loop tightly about an end of the brush.

In operation, the operator attaches an engine kill switch 11 to one's self via a clip or carabiner. The operator then starts the engine 50. It should be noted that the engine 50 may include a pull start, an electric start, or the like. The operator uses the handlebar 10 for steering and the speed control lever 12 to engage the transaxle drive 25 to propel the unit forward or reverse to a point of loading for the machine. Next, the operator turns the machine off and loads brush or limbs into one of the attachment methods mounted to the universal swivel mounted attachment such as the Open Claw Brush Clamping Apparatus 40. The operator re-engages the kill switch tether and starts the engine 50. The operator then uses the handlebar 10 to propel the unit forward while dragging or transporting the loaded materials to their destination.

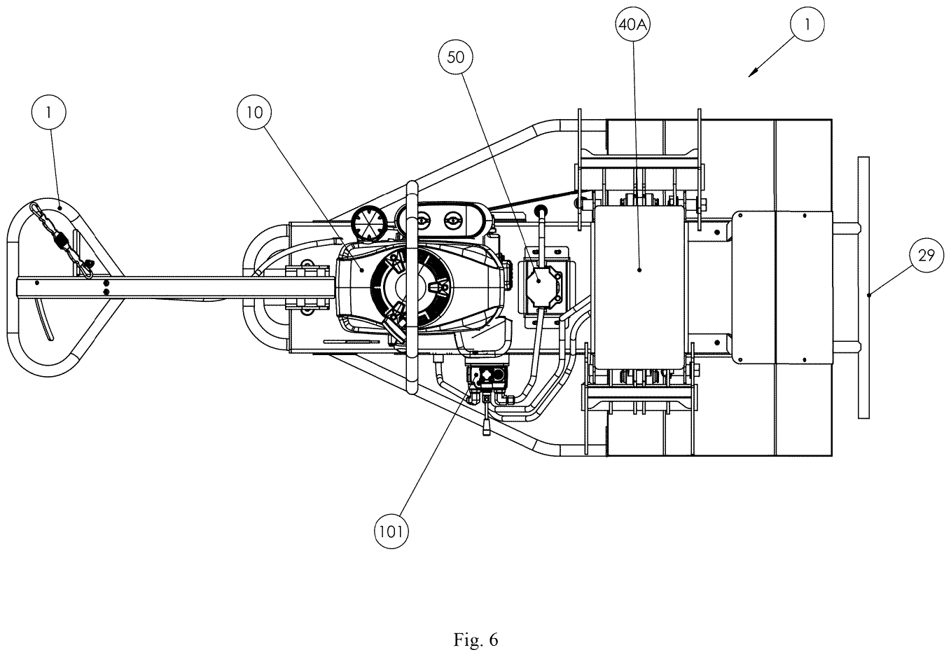

FIGS. 6A-12 show a second embodiment of the invention that includes a hydraulically actuated grapple or claw 40A. A locking differential is included in this embodiment to allow the rear wheels to be coupled together in a known manner to prevent one of the rear drive wheels from spinning when loaded and travelling over uneven and slippery terrain. A differential locking lever 55 engages/disengages the locking differential. In this second embodiment, protective bars 51A, 51B are provided along each side in front of the fenders to assist in preventing damage to the hydraulic features by sticks, limbs and other debris.

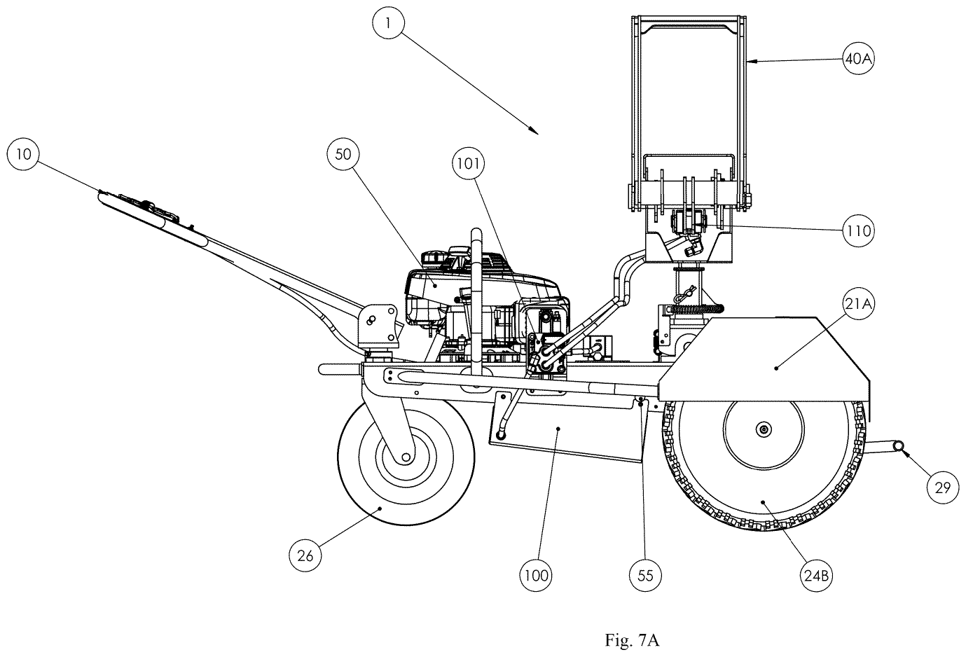

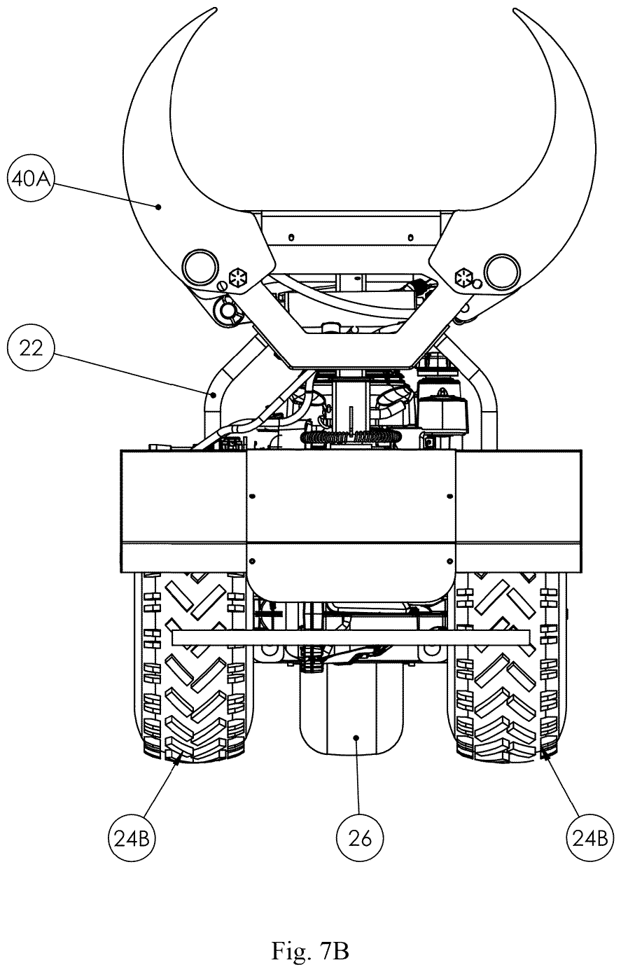

FIG. 6A shows an overhead view of the second embodiment. Handlebar 10 extends from the front of the machine 1. The hydraulic grapple 40A is arranged atop the machine 1 as shown in the associated second embodiment FIGS. 7A-12. A hydraulic valve 101 receives pressurized hydraulic fluid from the hydraulic pump 102 which turned via a belt 53A and Hydraulic Drive Pulley 152A. A pair of hydraulic hoses extend from the hydraulic valve 101 to a hydraulic cylinder 110 which opens and closes the hydraulic grapple 40A. The handle arranged on the hydraulic valve 101 may be moved in one direction to cause the grapple claw 40A to close and in an opposite direction to cause the grapple claw 40A to open. Brush, limbs or other debris may be arranged within the claw 40A which is thereafter closed until the material is hauled to a location to be loaded onto a truck for removal.

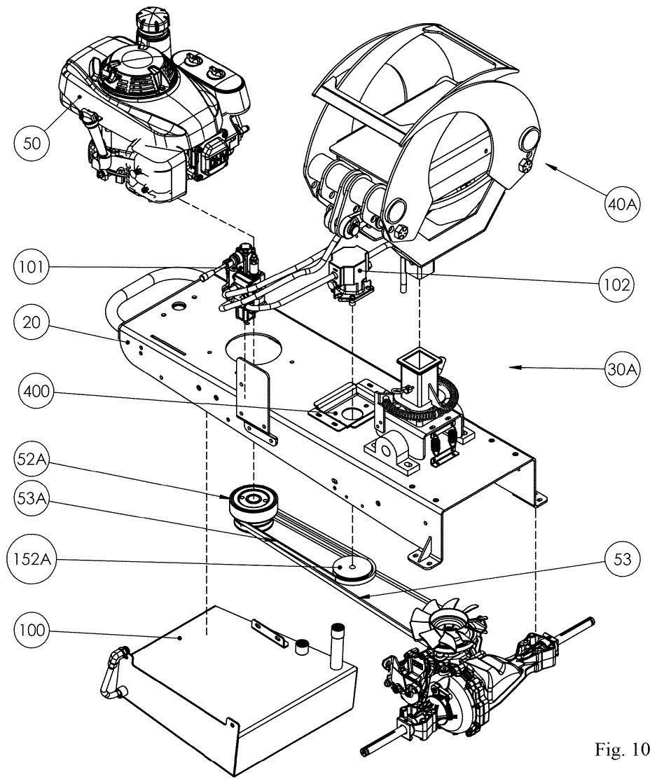

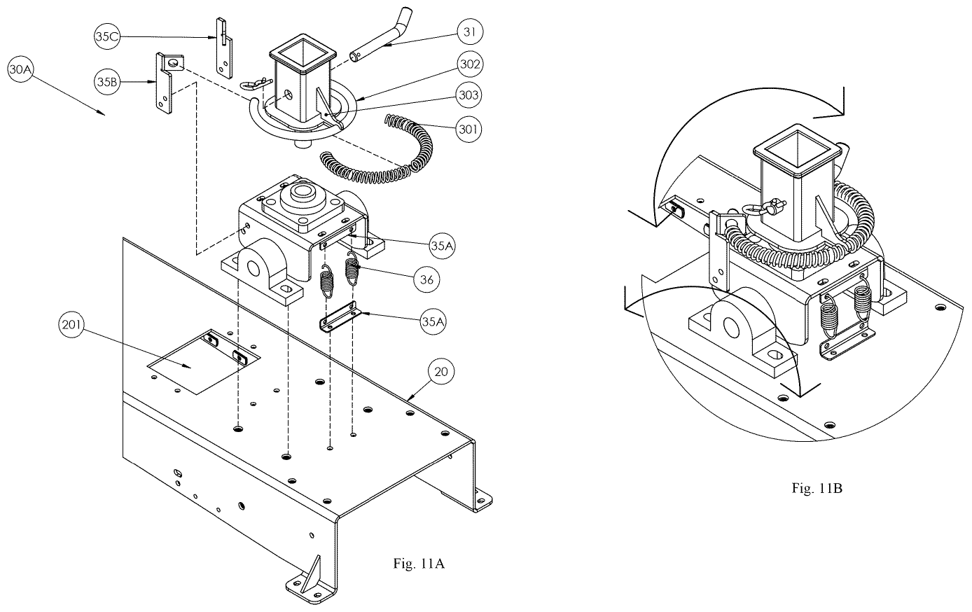

FIG. 7A shows the various parts of the machine 1 including the hydraulic fluid storage tank 100 which is affixed to a bottom side of the frame 20. A hose connects the hydraulic tank 100 to the hydraulic valve 101. Two hydraulic lines connect the hydraulic valve 101 to the hydraulic cylinder 110 to allow fluid to be pushed in either direction. In this manner, the hydraulic cylinder 110 is biased in an open or closed direction with respect to the hydraulic claw 40A. Differential lock lever 55 is arranged beneath the frame 20 in front of the fender 21A as shown. The operator may move it into a first position that will allow the rear drive wheels to spin independent of one another or into a second position which locks the two wheels together to prevent one or the other from spinning and losing traction. The locked position is useful when hauling over uneven, soft terrain. It should be noted that only an extendable wheelie bar 29 is shown without the wheels as in the first embodiment. In FIG. 7B, the hydraulic grapple 40A is shown in an open position which is used when no material is being hauled, during loading, and unloading of material to be hauled. In FIG. 10, the grapple 40A is shown in the closed position which is utilized for gripping materials to be hauled.

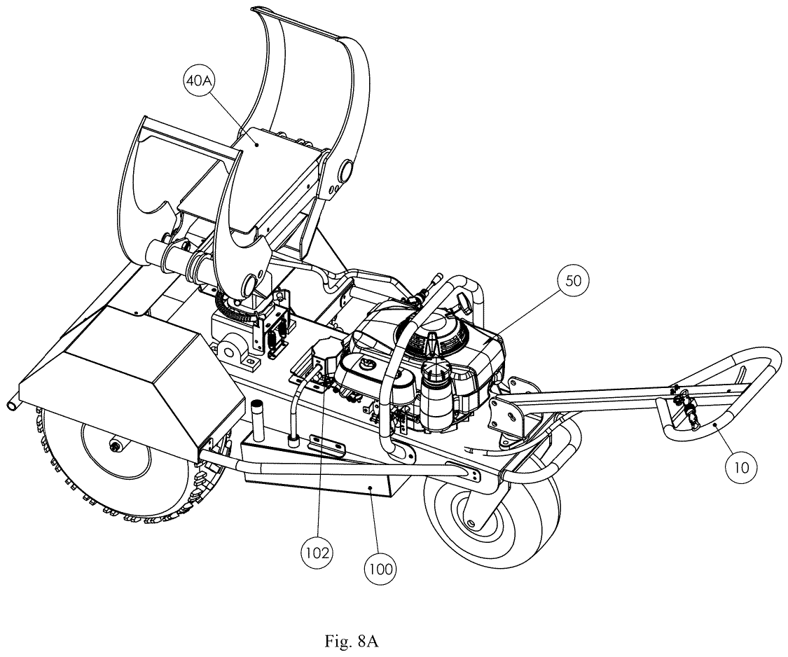

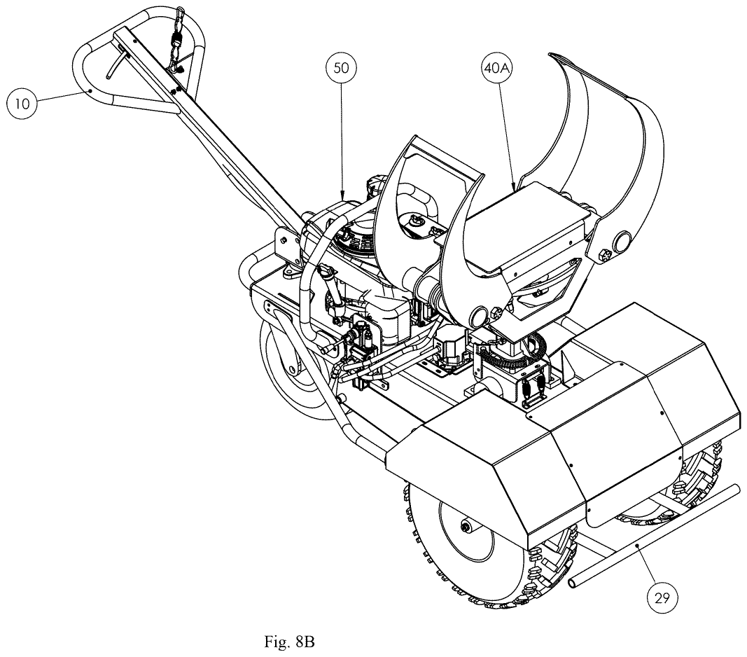

FIG. 8A is an elevated perspective view of the machine 1 of the second embodiment from the front and right side. FIG. 8B is an elevated perspective view of the machine 1 from the rear and left side. As can be understood from FIG. 8A, the hydraulic pump 102 is coupled to the hydraulic tank 100 via a hose on one side. FIG. 8B shows the hydraulic pump 102 coupled to the hydraulic valve 101 on an opposite via another hose. In this manner, hydraulic fluid may be drawn from the reservoir 100 and directed into opposite directions causing the hydraulic cylinder 110 to either open or close the grapple 40A.

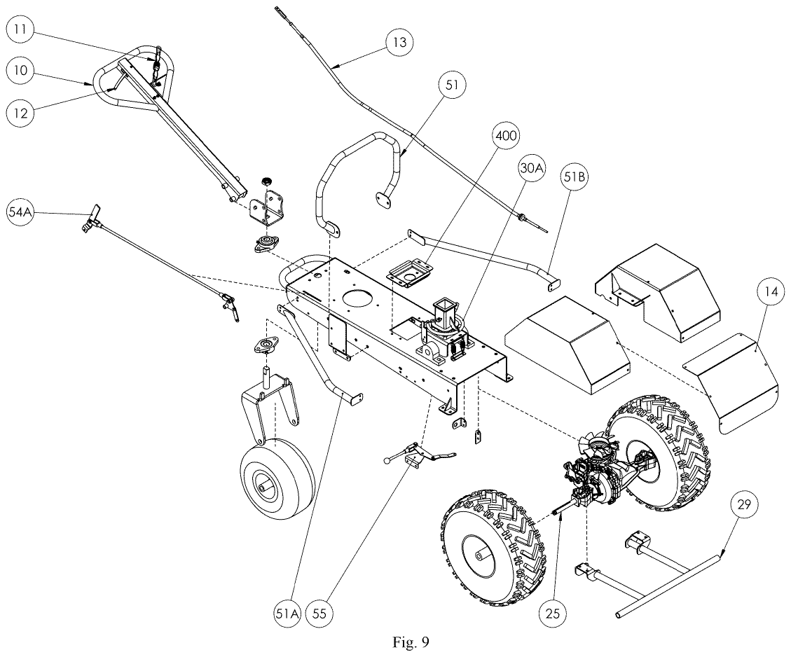

FIG. 9 shows the main frame and the various drive mechanism. Plate 400 is mounted in an opening 201 as can be more clearly understood when viewing FIGS. 10 and 11A. This plate 400 is utilized for mounting the hydraulic pump 102 to the frame 20. The freewheel/engagement lever 54A includes a linkage and is arranged at a front end of the machine 1.

FIG. 10 shows the engine and associated hydraulic parts. The engine 50 provides rotational energy which is harness by belts 53 and 53A to both drive the hydrostatic transmission 25 and the hydraulic pump 102 from beneath the frame 20 of the machine 1. The hydraulic valve 101 is mounted to the side of the frame 20 between the engine 50 and the hydraulic grapple 40A. The hydraulic tank 100 is mounted beneath the frame 20. The hydraulic pump is mounted to the frame via mount 400. The hydraulic grapple 40A is mounted atop the universal mount 30A.

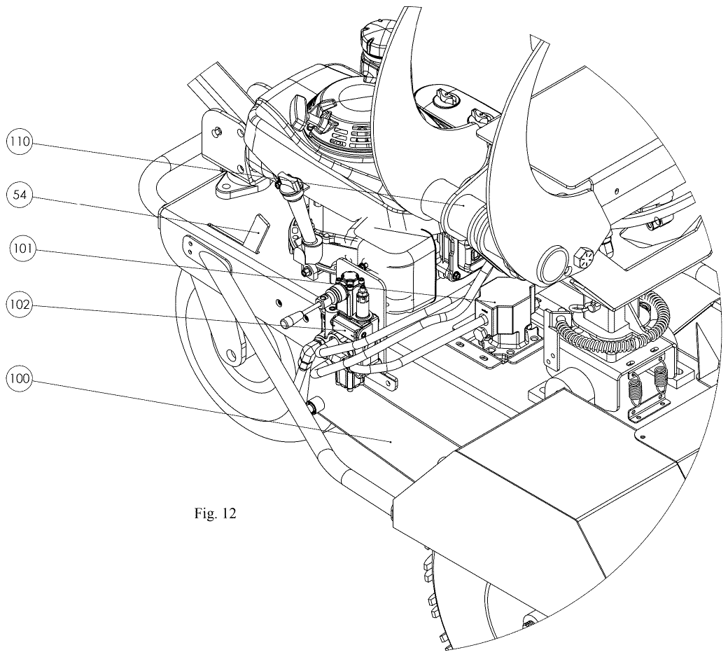

FIG. 11A is an exploded view of the second embodiment of the universal mount 30A and showing an enlarged view of the elements thereof. Spring mount 35A couples a pair of springs 36 between the universal mount 30A and the frame 20 to return the universal mount 30A to an upright position when the load is removed from the grapple 40, 40A. A hitch pin 31 fastens the grapple 40A to the universal mount 30A. Spring support 35B and 36 support spring 301 to cause the universal mount to spin and return to a correct position to align the grapple 40A across the machine 1 for ease in loading. A spring 301 is mounted about an arcuate metal rod 302 for support and to prevent the spring 301 from sagging. A back spring support supports the arcuate metal rod 302 as well as spring support 35B as more clearly shown in FIG. 11B. Arrows show the direction of possible rotation of the mount 30A. FIG. 12 shows a partial enlarged view of the various elements of the hydraulic system and the universal mount.

Several embodiments of the present invention have been described herein. It should be understood by those of ordinary skill in the art, however, that the above-described embodiments, are set forth merely by way of example and should not be interpreted as limiting the scope of the invention. Other alternative embodiments, variations and modifications of the foregoing embodiments that embrace various aspects of the present invention will also be understood upon reading of the detailed description in light of the prior art.

We claim:

1. A compact motorized hauling apparatus comprising:
a frame having a front end, a rear end, a top side and a bottom side ;
an engine mounted on the frame substantially near the front end;
a pair of drive wheels mechanically coupled to the engine for propelling the apparatus in a forward or rearward direction;
a hydrostatic transmission coupled to the engine and the pair of drive wheels and which receives power from the engine and delivers it to the pair of drive wheels to cause the apparatus to move in either the forward or rearward direction;
a steering handle arranged at an end of the frame and having a first end and a second end, said second end being rotatably affixed to the frame via a bearing and coupled to a steering caster such that the steering handle may be elevated to a desired height and traversed in a left and right direction with respect to the front of the frame to cause the apparatus to be steered in a desired direction, the first end having a lever which is actuated to cause the apparatus to move in either the forward or rearward direction and which is biased in a neutral position when released by a hand of a user;
a self-leveling universal mount comprising a base fastened to top side of the frame via a pair of pillow bearings arranged on opposite sides of the self-leveling universal mount which allow it to pivot in a forward and a rearward direction, a bearing arranged substantially in the center of a top of the base which allows the self-leveling universal mount to turn left and right directions with respect to the frame, at least one spring arranged between the self-leveling universal mount to cause the mount to self-level, said self-leveling universal mount further comprising a metal receptacle that receives a hitch pin which fastens a brush clamping apparatus; and,
a grapple device arranged atop the self-leveling universal mount for receiving material to be hauled.

2. The compact motorized hauling apparatus of claim 1 wherein the grapple device further comprises:
a hydraulic grapple having a hydraulic cylinder arranged to open and close the hydraulic grapple;
a hydraulic tank that stores hydraulic fluid for actuating the hydraulic grapple to cause it to open and close;
a hydraulic pump connected to the hydraulic tank and the hydraulic cylinder via at least one hose to pump hydraulic fluid into and out of the hydraulic cylinder causing the hydraulic cylinder to extend or retract to thereby open and close the hydraulic grapple; and,
a valve connected between the hydraulic tank and the hydraulic cylinder via hoses which causes hydraulic fluid to be pumped into the hydraulic cylinder in a first position and which causes hydraulic fluid to be pumped out of the hydraulic cylinder in a second position.

3. The compact motorized hauling apparatus of claim 1 further comprising a winch arranged on the apparatus for securing a load to the grapple device and having a cable which comprises a a loop that secures material to be hauled to the grapple device, said winch further comprising a handle which is rotated to close the loop about the material to be hauled.

4. The compact motorized hauling apparatus of claim 1 further comprising an extendible wheelie bar and wheels to prevent the steering caster from raising off the ground when material to be hauled is secured to the grapple device.

5. The compact motorized hauling apparatus of claim 1 further comprising fenders that fastened to the frame and which extend across the pair of drive wheels to protect them from material being hauled; and,
brush guards which extend from either side of the engine to protect it.

6. The compact motorized hauling apparatus of claim 1 further comprising a transaxle engagement lever coupled to the pair of drive wheels to lock them together such that neither drive wheel can spin without the other, said transaxle engagement lever having a first position which allows the pair of drive wheels to spin independently of one another and a second position which causes the pair of drive wheels to be coupled together to prevent spinning.

7. The compact motorized hauling apparatus of claim 1 further comprising a freewheel engagement lever having a first position which engages the drive wheels with the engine and a second position which disconnects the pair of drive wheels from the engine to allow the compact motorized hauling apparatus to be moved freely by the user in a forward or reverse direction.

8. The compact motorized hauling apparatus of claim 1 wherein the self-leveling universal mount further comprises an arcuate spring support having a spring arranged thereon which causes the metal receptacle to be returned to an original position upon removal of material being hauled from the grapple device.

9. A motorized hauling apparatus comprising:
a frame having a front end, a rear end, a top side and a bottom side ;
an engine mounted on the frame substantially near the front end;
a pair of drive wheels mechanically coupled to the engine for propelling the apparatus in a forward or rearward direction;
a hydrostatic transmission coupled to the engine and the pair of drive wheels and which receives power from the engine and delivers it to the pair of drive wheels to cause the apparatus to move in either the forward or rearward direction;
a steering handle arranged at an end of the frame and having a first end and a second end, said second end being rotatably affixed to the frame via a bearing and coupled to a steering caster such that the steering handle may be elevated to a desired height and traversed in a left and right direction with respect to the front of the frame to cause the apparatus to be steered in a desired direction, the first end having a lever which is actuated to cause the apparatus to move in either the forward or rearward direction and which is biased in a neutral position when released by a hand of a user;
a self-leveling universal mount comprising a base fastened to top side of the frame via a pair of pillow bearings arranged on opposite sides of the self-leveling universal mount which allow it to pivot in a forward and a rearward direction, a bearing arranged substantially in the center of a top of the base which allows the self-leveling universal mount to turn left and right directions with respect to the frame, at least one spring arranged between the self-leveling universal mount to cause the mount to self-level, said self-leveling universal mount further comprising a metal receptacle that receives a hitch pin which fastens a brush clamping apparatus;
a hydraulic grapple having a hydraulic cylinder arranged to open and close the hydraulic grapple;
a hydraulic tank fastened to the frame and that stores hydraulic fluid for actuating the hydraulic grapple to cause it to open and close;
a hydraulic pump connected to the hydraulic tank and the hydraulic cylinder via at least one hose to pump hydraulic fluid into and out of the hydraulic cylinder causing the hydraulic cylinder to extend or retract to thereby open and close the hydraulic grapple; and,
a valve connected between the hydraulic tank and the hydraulic cylinder via hoses which causes hydraulic fluid to be pumped into the hydraulic cylinder in a first position and which causes hydraulic fluid to be pumped out of the hydraulic cylinder in a second position.

10. The compact motorized hauling apparatus of claim 1 further comprising an extendible wheelie bar and wheels to prevent the steering caster from raising off the ground when material to be hauled is secured to the grapple device.

11. The compact motorized hauling apparatus of claim 9 further comprising fenders that fastened to the frame and which extend across the pair of drive wheels to protect them from material being hauled; and,
brush guards which extend from either side of the engine to protect it.

12. The compact motorized hauling apparatus of claim 9 further comprising a transaxle engagement lever coupled to the pair of drive wheels to lock them together such that neither drive wheel can spin without the other, said transaxle engagement lever having a first position which allows the pair of drive wheels to spin independently of one another and a second position which causes the pair of drive wheels to be coupled together to prevent spinning.

13. The compact motorized hauling apparatus of claim 9 further comprising a freewheel engagement lever having a first position which engages the drive wheels with the engine and a second position which disconnects the pair of drive wheels from the engine to allow the compact motorized hauling apparatus to be moved freely by the user in a forward or reverse direction.

14. The compact motorized hauling apparatus of claim 9 wherein the self-leveling universal mount further comprises an arcuate spring support having a spring arranged thereon which causes the metal receptacle to be returned to an original position upon removal of material being hauled from the grapple device.

15. A motorized hauling apparatus comprising:
a frame having a front end, a rear end, a top side and a bottom side ;
an engine mounted on the frame;
a pair of drive wheels mechanically coupled to the engine for propelling the apparatus in a forward or rearward direction;
a hydrostatic transmission coupled to the engine and the pair of drive wheels and which receives power from the engine and delivers it to the pair of drive wheels to cause the apparatus to move in either the forward or rearward direction;
a steering handle arranged at an end of the frame and being rotatably affixed to the frame via a bearing;
a steering caster affixed to the steering handle such that the steering handle may be traversed in a left and right direction to cause the apparatus to be steered in a desired direction, the first end
a lever mounted to the steering handle that is actuated to cause the apparatus to move in either the forward or rearward direction and said lever being biased towards a neutral position when released by a hand of a user such that power is not delivered from the engine to the pair of drive wheels when in the neutral position;
a self-leveling universal mount comprising a base fastened to top side of the frame via a pair of pillow bearings arranged on opposite sides of the self-leveling universal mount which allow it to pivot in a forward and a rearward direction, a bearing arranged substantially in the center of a top of the base which allows the self-leveling universal mount to turn left and right directions with respect to the frame, at least one spring arranged between the self-leveling universal mount to cause the mount to self-level, said self-leveling universal mount further comprising a metal receptacle that receives a hitch pin which fastens a brush clamping apparatus;
a hydraulic grapple having a hydraulic cylinder arranged to open and close the hydraulic grapple;
a hydraulic tank fastened to the frame and that stores hydraulic fluid for actuating the hydraulic grapple to cause it to open and close;
a hydraulic pump connected to the hydraulic tank and the hydraulic cylinder via at least one hose to pump hydraulic fluid into and out of the hydraulic cylinder causing the hydraulic cylinder to extend or retract to thereby open and close the hydraulic grapple; and,
a valve connected between the hydraulic tank and the hydraulic cylinder via hoses which causes hydraulic fluid to be pumped into the hydraulic cylinder in a first position and which causes hydraulic fluid to be pumped out of the hydraulic cylinder in a second position.

16. The motorized hauling apparatus of claim 15 further comprising an extendible wheelie bar and wheels to prevent the steering caster from raising off the ground when material to be hauled is secured to the grapple device.

17. The compact motorized hauling apparatus of claim 15 further comprising fenders that fastened to the frame and which extend across the pair of drive wheels to protect them from material being hauled; and,
brush guards which extend from either side of the engine to protect it.

18. The motorized hauling apparatus of claim 15 further comprising a transaxle engagement lever coupled to the pair of drive wheels to lock them together such that neither drive wheel can spin without the other, said transaxle engagement lever having a first position which allows the pair of drive wheels to spin independently of one another and a second position which causes the pair of drive wheels to be coupled together to prevent spinning.

19. The motorized hauling apparatus of claim 15 further comprising a freewheel engagement lever having a first position which engages the drive wheels with the engine and a second position which disconnects the pair of drive wheels from the engine to allow the compact motorized hauling apparatus to be moved freely by the user in a forward or reverse direction.

20. The motorized hauling apparatus of claim 15 wherein the self-leveling universal mount further comprises an arcuate spring support having a spring arranged thereon which causes the metal receptacle to be returned to an original position upon removal of material being hauled from the grapple device.
